(19) United States
(12) Patent Application Publication
(10) Pub. No.: US 2026/0105632 A1
(43) Pub. Date: Apr. 16, 2026

(54) DATA ANALYTICS-BASED POLE CHARACTERIZATION USING CLOUD DATA

(71) Applicant: INTERNATIONAL BUSINESS MACHINES CORPORATION, Armonk, NY (US)

(72) Inventors: Zhangziman SONG, Jersey City, NJ (US); Gurkanwar SINGH, New York, NY (US); Anjani Prasad ATLURI, Jersey City, NJ (US); Harini SRINIVASAN, Tarrytown, NY (US); Estepan MELIKSETIAN, Ridgefield, CT (US); Kewen GU, Jersey City, NJ (US)

(21) Appl. No.: 18/916,846

(22) Filed: Oct. 16, 2024

(51) Int. Cl. G06T 7/73; G01S 17/42; G01S 17/894; G06T 7/00; G06T 7/194

(52) U.S. Cl. CPC G06T 7/75; G01S 17/42; G01S 17/894; G06T 7/0002; G06T 7/194; G06T 2207/10028; G06T 2207/20081; G06T 2207/30184

(57) ABSTRACT

A data analytics-based pole characterization process is provided which includes receiving Light Detection and Ranging (LIDAR) pole point clusters derived from 3D LIDAR point cloud data, where the clusters correspond to multiple pole locations. The process further includes processing, using one or more machine learning models, a pole point cluster for a pole location. The processing includes fitting a 3D line representation of a pole at the pole location to the pole point cluster, where the fitting includes segmenting pole points of the cluster along the z-axis direction to obtain one or more pole point segments, and using at least one pole point segment in fitting the 3D line representation of the pole to the pole point cluster. Further, the processing includes determining from the 3D line representation a lean angle of the pole, and outputting an indication of the lean angle of the pole.

### BACKGROUND

One or more aspects relate, in general, to improving processing within a computing environment, and in particular, to improving data analytics-based processing to characterize a pole, such as a utility pole, using 3D LIDAR point cloud data.

The need to identify and remediate or replace leaning poles is an issue often encountered in utility networks. A pole can lean from its original position due to a variety of factors, including weather conditions, such as heavy wind, loosened soil from heavy precipitation, as well as human related impacts, such as accidents. Utility companies reduce the risks associated with leaning poles by either replacing them, or further pinning them to the ground using additional wires (e.g., guy wires), so that the poles do not pose as great a risk of falling. An unaddressed leaning pole can potentially fall, resulting in harm to individuals or surrounding buildings, or cause power outages and/or initiate a wildfire. A typical utility territory can have thousands or potentially tens of thousands of poles to be monitored, which is conventionally accomplished by manually inspecting each utility pole, which can be time consuming and expensive.

Light Detection and Ranging (LIDAR) or Laser Imaging, Detection and Ranging, is a technology that can scan a terrain and objects within the terrain to determine ranges. In operation, a LIDAR device uses a laser and measures the time it takes for reflected light to return to the LIDAR device's sensors. The LIDAR device produces LIDAR point clouds, which are collections of millions of points that represent the terrain and location of objects within the scanned area. The points refer to data points that map a particular scanned object or feature using the LIDAR device. A point cloud cluster, or point cluster, refers to point data related to a particular object within the point cloud detected by a LIDAR scan.

### SUMMARY

Certain shortcomings of the prior art are overcome, and additional advantages are provided herein through the provision of a computer-implemented method which includes receiving, by a computing device over one or more networks, light detection and ranging (LIDAR) pole point clusters, where the LIDAR pole point clusters are derived from 3D LIDAR point cloud data obtained from LIDAR sensors on one or more devices. The pole point clusters correspond to multiple pole locations within a geographic region of interest. The method further includes processing, by the computing device using one or more machine learning models, a pole point cluster for a pole location of the multiple pole locations. The processing includes fitting a 3D line representation of a pole at the pole location to the pole point cluster, where the fitting includes, in one or more embodiments, segmenting a plurality of pole points of the pole point cluster at the pole location along a z-axis direction to obtain one or more pole point segments in the z-axis direction, and using at least one pole point segment of the one or more pole point segments in fitting the 3D line representation of the pole at the pole point location to the pole point cluster. The processing further includes determining from the 3D line representation a lean angle of the pole at the pole location. In addition, the method includes outputting, by the computing device, an indication of the lean angle of the pole at the pole location.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to include and/or use one or more aspects of the present disclosure;

FIG. 1B depicts another example of a computing environment to include and/or use one or more aspects of the present disclosure;

FIG. 2A-2B depict one embodiment of a computer program product with pole characterization code, in accordance with one or more aspects of the present disclosure;

FIG. 3 depicts one embodiment of a pole characterization process, in accordance with one or more aspects of the present disclosure;

FIG. 4A depicts one embodiment of a tall point cluster with a 3D line fitted to centroids of a plurality of pole point segments obtained from segmenting the pole point cluster, in accordance with one or more aspects of the present disclosure;

FIG. 4B depicts one embodiment of a wide point cluster with a 3D line fitted to a selected pole point segment with a largest XY coverage area, in accordance with one or more aspects of the present disclosure;

FIG. 5 depicts a further embodiment of a data analytics-based pole characterization workflow, in accordance with one or more aspects of the present disclosure; and

FIG. 6 depicts a further embodiment of a data analytics-based pole characterization workflow, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

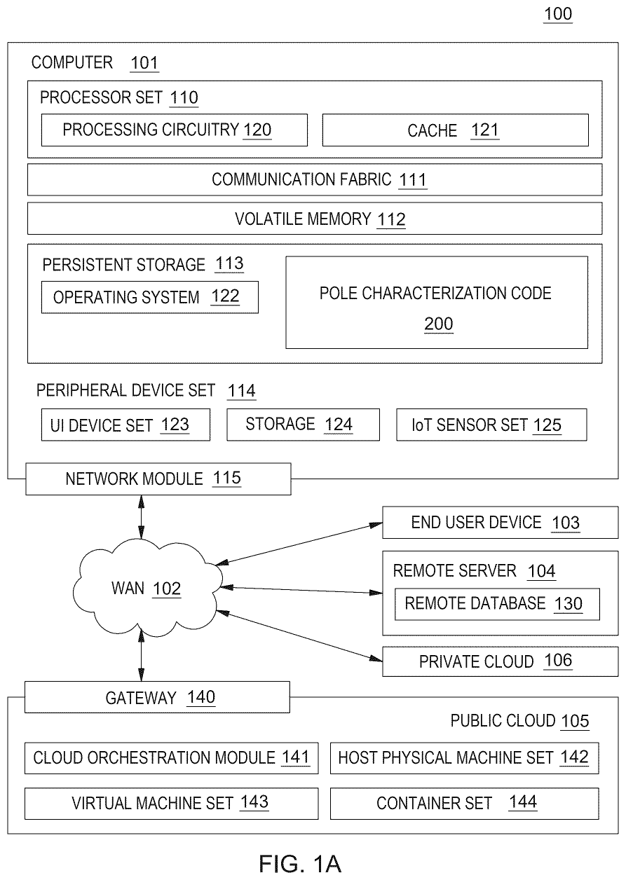

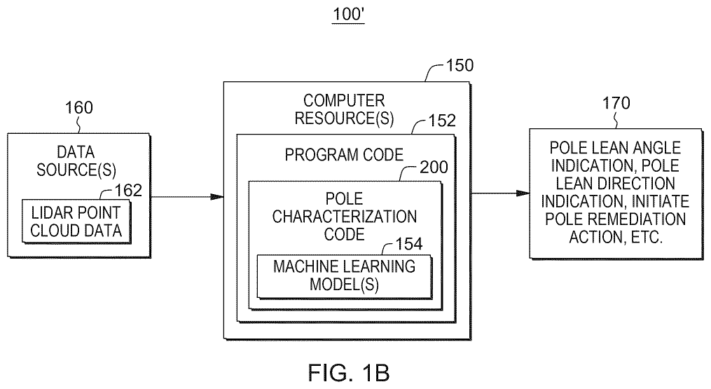

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and pole characterization code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1A, computing environment 100 contains an example of an environment for the execution of at least some of the computer code involved in performing the inventive methods, such as pole characterization code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1A. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data-analytics-based pole characterization code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1A): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1A need not be included in the computing environment and/or are not used for one or more aspects of the present disclosure. Further, in one or more embodiments, additional and/or other components/modules can be used. Other variations are possible.

By way of further example, FIG. 1B depicts another embodiment of a computing environment 100′, which can incorporate, use or implement, one or more aspects of an embodiment of the present disclosure. In one or more embodiments, computing environment 100′ is implemented as part of, or includes, a computing environment such as computing environment 100 described above in connection with FIG. 1A. Computing environment 100′ contains one or more computer resources 150, such as one or more computers 101 of FIG. 1A, connected to receive (e.g., obtain, access, etc.) data from one or more data sources 160, such as LIDAR point cloud data 162 from one or more LIDAR point cloud data sources. For instance, the data source(s) includes one or more LIDAR devices, one or more databases containing LIDAR point cloud data, one or more computer resources containing or transmitting LIDAR point cloud data, etc. In one or more embodiments, the LIDAR point cloud data 162 can be, or include, classified LIDAR point cloud data which includes a plurality of LIDAR pole point clusters derived from the 3D LIDAR point cloud data, where the data was obtained, for instance, from LIDAR sensors on one or more devices. In one or more embodiments, each pole point cluster contains data points for a respective pole location of interest, such as a respective utility pole location within a utility infrastructure.

In embodiments, the one or more computer resources 150 execute program code 152 that implements, for instance, one or more aspects of pole characterization code 200, such as disclosed herein. In one or more embodiments, pole characterization code 200 includes, or utilizes, one or more machine learning models 154, which can be part of pole characterization code 200 or accessed by pole characterization code 200. Pole characterization code 200 facilitates data analytics-based processing associated with characterizing a pole, such as for utility company. In embodiments, the pole characterization code receives Light Detection and Ranging (LIDAR) point cloud data, such as, or including, pole point clusters, with (as noted) the LIDAR pole point clusters being derived from 3D LIDAR point cloud data obtained from LIDAR sensors on one or more devices. The pole point clusters correspond to multiple pole locations within a geographical region of interest. In embodiments, the pole characterization code is data analytics-based code for processing, using one or more machine learning models 154, a pole point cluster for a pole location of the multiple pole locations. The processing includes fitting a 3D line representation of a pole at the pole location to the pole point cluster, where the fitting includes segmenting a plurality of pole points of the pole point cluster at the pole location along the z-axis direction to obtain one or more pole point segments in the z-axis direction, and using at least one pole point segment of the one or more pole point segments in fitting the 3D line representation of the pole at the pole location to the pole point cluster. Further, the processing includes determining from the 3D line representation one or more pole characteristics, including, for instance, a lean angle of the pole at the pole location and/or a direction of pole lean. In embodiments, the pole characterization code 200 provides one or more indications, such as a pole lean angle indication, pole lean direction indication, and/or initiates one or more actions, such as one or more pole remediation or replacement actions, etc. 170. In one or more aspects, pole characterization code 200, in addition to providing an indication of one or more pole characteristics, such as lean angle, lean direction, etc., initiates a remediation action (e.g., repair, replace, maintain and/or inspect, etc.) based, for instance, on the determined lean angle exceeding a specified threshold. In one example, a remediation action is initiated by automatically sending, for instance, an indication to commence the action. As an example, the indication is sent by a computer (e.g., computer 101 of FIG. 1A) a processor of a processer set (e.g., processor set 110 (FIG. 1A)) and/or processing circuitry of a processor set (e.g., processor set 110) (FIG. 1A) to a computing or electronic component that receives the indication and automatically initiates the action. Alternatively, or additionally, the one or more indications can be sent to a utility worker, group, or other entity that initiates and/or performs the remediation action. Based on initiating the remediation action, the action is performed. As examples, a pole can be replaced, or further supported, for instance, by an additional pole, by one or more guy wires, etc. One or more aspects of this remediation action can be performed manually and/or automatically (e.g., using one or more robotic devices). Many possibilities exist.

In one or more implementations, computing environment 100′ can include, or utilize, one or more networks for interfacing various aspects of computing resource(s) 150, as well as one of or more other controllers, components, systems, etc., receiving a result, action, instruction, etc. 170 of the pole characterization code 200 in a manner that facilitates processing of data within the computing environment. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and transmitting data, including training data for one or more artificial intelligence (AI) agents of the pole characterization code, and an output solution, recommendation, action of the pole characterization code, such discussed herein.

In one or more implementations, computer resource(s) 150 house and/or execute program code 152 configured to perform computer-implemented methods in accordance with one or more aspects of the present disclosure. By way of example, computer resource(s) 150 can be a computing-system-implemented resource(s). Further, for illustrative purposes only, computing resource(s) 150 in FIG. 1B is depicted as being a single computer resource. This is a non-limiting example of an implementation. In one or more other embodiments, computer resource(s) 150, which implements one or more aspects of processing such as discussed herein, can, at least in part, be implemented in multiple separate computer resources or systems, such as one or more computer resources of a cloud-hosting environment, by way of example.

Briefly described, in one embodiment, computer resource(s) 150 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the pole characterization code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 152 includes, executes, accesses, etc., one or more artificial intelligence agents which (in one or more embodiments) can train and/or use one or more machine learning models 154 that embody (in part), or are used by, the pole characterization code 200. The artificial intelligence agent(s) can be an existing artificial intelligence (AI) agent or existing AI tool and/or can include, or use, one or more machine learning models that can be pretrained using training data that can include a variety of types of LIDAR point cloud data. In one or more embodiments, program code 152 executing on one or more computer resources 150 applies one or more algorithms of, for instance, the artificial intelligence agent(s) to generate and train the model(s) 154, which the program code then utilizes to, for instance, implement one or more aspects of pole characterization code 200. In an initialization or learning stage, program code 152 can train the one or more machine learning models using obtained training data to implement, for instance, one or more aspects of the code, functions, modules and/or tools described herein.

Data used to train the models (in one or more embodiments of the present disclosure) can include a variety of types of LIDAR point cloud data, such as LIDAR point cloud data 162, which as noted can include, in one or more embodiments, classified LIDAR pole point data. In one or more other embodiments, the LIDAR point cloud data can be unclassified LIDAR data, with the point cloud data undergoing classification as part of the pole characterization process. Program code, in embodiments of the present disclosure, can perform data analysis to generate data structures, including algorithms utilized by the program code to implement one or more aspects of the pole characterization code and/or initiate (or perform) an action related thereto. As known, machine learning-based modeling solves problems that cannot be solved by numerical means alone. In one example, program code extracts features/attributes from the training data, which can be stored in memory or one or more databases. The extracted features can be utilized to develop a predictor function, h(x), also referred to as a hypothesis, which the program code utilizes as a model. In identifying machine learning model(s), various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weigh various attributes (e.g., features, patterns) that correlate to enhanced performance of the model.

In one or more embodiments, program code, executing on one or more processors, utilizes one or more artificial intelligence agents (now known or later developed) to facilitate implementing one or more aspects disclosed herein. In one or more embodiments, the program code can interface with application programming interfaces to perform a cognitive analysis of obtained and/or converted data. Specifically, in one or more embodiments, certain application programing interfaces include a cognitive agent (e.g., learning agent) that includes one or more programs, including, but not limited to, natural language classifiers, a retrieve-and-rank service that can surface the most relevant information, concepts/visual insights, tradeoff analytics, document conversion, and/or relationship extraction. In an embodiment, one or more programs analyze the data obtained by the program code from one or more sources utilizing one or more of a natural language classifier, retrieve-and-rank application programming interfaces, and tradeoff analytics application programing interfaces, etc.

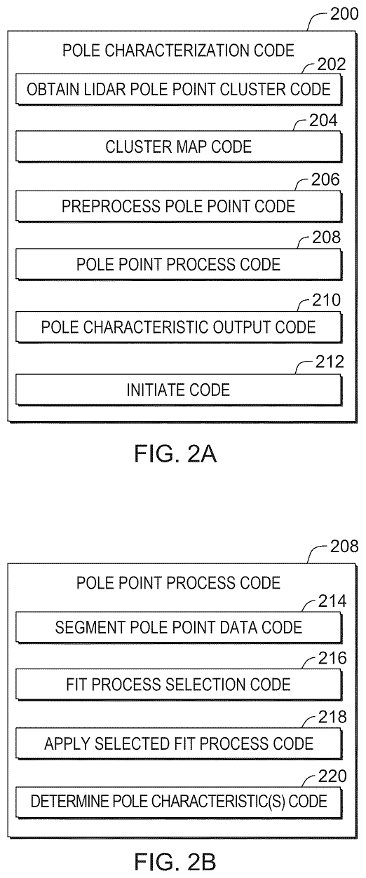

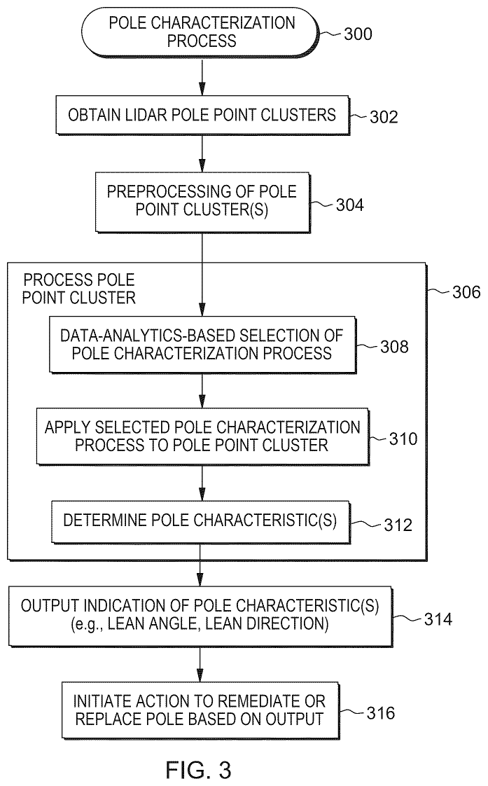

By way of example, one or more embodiments of a pole characterization code and workflow are described initially with reference to FIGS. 2A-3. FIGS. 2A-2B depict one embodiment of pole characterization code 200 that includes code or instructions to perform pole characterization, in accordance with one or more aspects of the present disclosure, and FIG. 3 depicts one embodiment of a pole characterization process, in accordance with one or more aspects of the present disclosure.

Referring to FIGS. 1A-2B, pole characterization code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101 (FIG. 1A) and/or computer resource(s) 150 (FIG. 1B); one or more processor sets 110 (FIG. 1A); processors, such as one or more processors of processor set 110; and/or processing circuitry, such as processing circuity of processor set 110, etc.

As noted, FIGS. 2A-2B depict one embodiment of pole characterization code 200 which, in one or more implementations, includes, or facilitates, pole characterization processing in accordance with one or more aspects of the present disclosure. In the embodiment of FIGS. 2A-2B, example code of pole characterization code 200 includes obtain LIDAR pole point cluster code 202 to obtain (e.g., receive, retrieve, generate, etc.) LIDAR pole point clusters. The LIDAR pole point clusters were, or are, derived from 3D LIDAR pole point data obtained from LIDAR sensors on one or more devices. In one or more embodiments, the pole point clusters correspond to, and identify, multiple pole locations within a geographic region of interest, such as within a utility company's geographic region of service.

In one or more embodiments, pole characterization code 200 further includes cluster map code 204 to, for instance, compare the pole point clusters to Geographical Information System (GIS) data for a utility's service area or network area to further map the multiple pole locations within the geographic region of interest to the particular utility's network.

In one or more embodiments, pole characterization code 200 includes preprocess pole point code 206 to preprocess the pole point data to, for instance, determine whether there is a sufficient number of data points to fit a 3D line representation of the pole at the pole location, or to identify, for instance, a transmission pole versus utility pole, and/or to clean or filter a pole point cluster to, for instance, remove point data corresponding to one or more guy wires, or other structures attached to the pole.

In one or more embodiments, pole characterization code 200 includes pole point process code 208 which, as shown in the embodiment of FIG. 2B, can include segment pole point data code 214 to segment a plurality of pole points of the pole point cluster at the pole location along the z-axis direction to obtain one or more pole point segments in the z-axis direction. In addition, the pole point process code 208 can include, in one or more embodiments, fit process selection code 216 to determine which pole characterization process of multiple pole characterization processes is to be used, and apply the selected fit process code 218. In one or more embodiments, the multiple pole characterization processes can include a tall cluster process and a wide cluster process, as disclosed herein. In one or more embodiments, pole characterization code 200 further includes determine pole characteristic(s) code 220 to, for instance, determine from the 3D line representation fitted to the pole point cluster a lean angle for the pole at the pole location.

As in illustrated in FIG. 2A, in one or more embodiments, pole characterization code 200 further includes pole characteristic output code 210 to output an indication of, for instance, the pole characteristic, such as lean angle of the pole at the pole location, and/or lean direction of the pole. In one or more embodiments, pole characterization code 200 further includes initiate code 212 to initiate one or more actions to, for instance, remediate a leaning pole by adding support to the pole and/or replacing a leaning pole, etc.

Note also that although various code or sub-modules are described herein, a pole characterization code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the pole characterization code is used, in accordance with one or more aspects of the present disclosure, to perform pole characterization processing. FIG. 3 depicts one example of a pole characterization process 300, such as disclosed herein. The process is executed, in one or more embodiments, by a computer (e.g., computer 101 (FIG. 1A), computer resource(s) 150 (FIG. 1B)), and/or one or more processor sets, such as a processor or processing circuitry (e.g., of processor set 110 of FIG. 1A). In one example, code or instructions implementing the process, are part of a code or module, such as pole characterization code 200 of FIGS. 1A-2B. In other examples, the code can be included in one or more other modules and/or one or more other sub-modules of one or more other modules. Various options are available.

As illustrated in FIG. 3, in one example, pole characterization process 300 executing on one or more computers (e.g., computer 101 of FIG. 1A), one or more processor sets (e.g., processor set 110 of FIG. 1A, such as a processor or processing circuitry of the processor set) performs pole characterization processing such as described herein, which includes, in one or more embodiments, obtaining LIDAR pole point clusters 302, which can include receiving, retrieving, generating, etc. the desired LIDAR pole point clusters from LIDAR point cloud data. For instance, in one or more embodiments, the LIDAR pole point clusters are identified or classified from 3D LIDAR point cloud data obtained from LIDAR sensors on one or more aerial devices. In one or more embodiments, the pole point clusters correspond to, or identify, multiple pole locations within a geographic region of interest. In one or more embodiments, pole characterization process 300 further includes preprocessing the pole point clusters 304 to, for instance, remove any pole point cluster with insufficient number of data points, as well as to select a best pole characterization process of multiple pole characterization processes based on data analysis of the pole point cluster at issue. Further, the preprocessing can include, in one or more embodiments, removing pole point data representative of additional structures, such as one or more structures connected to the pole (e.g., one or more guy wires, transformers, etc.) to clean the pole point data for processing.

In one or more embodiments, pole characterization process 300 further includes processing the pole point cluster 306, which includes, for instance, processing, by a computing device using one or more machine learning models, the pole point cloud cluster for a pole location of the multiple pole locations. In one or more embodiments, processing pole point cluster 306 includes segmenting a plurality of pole points of the pole point cluster at the pole location along the z-axis to obtain one or more pole point segments in the z-axis direction, one or more of which are then used in fitting a 3D line representation of the pole to the pole point cluster at the pole location. In embodiments, processing the pole point cluster 306 includes data analytics-based selection of a pole characterization process 308 of multiple pole characterization processes. In one or more embodiments, selection of the pole characterization process is pursuant to data analytics-based evaluation of the pole point cluster at issue to determine, for instance, a best pole characterization process to be used for the particular cluster of data points. In one or more embodiments, the multiple pole characterization processes include a tall cluster process and a wide cluster process, such as described further herein. In one or more embodiments, processing the pole point cluster 306 further includes applying the selected pole characterization process to the pole point cluster 310 to, for instance, obtain a 3D line representation of the pole at the pole location. In embodiments, processing the pole point cluster 306 further includes determining one or more pole characteristics using the 3D line representation fitted to the pole point cloud cluster 312. For instance, in one or more embodiments, the one or more characteristics can include a pole lean angle, a direction of pole lean, pole height, etc.

In one or more embodiments, pole characterization process 300 can include outputting an indication of the one or more determined pole characteristics, such as a lean angle, lean direction, etc., 314. In one or more embodiments, pole characterization process 300 further initiates a remediate action to remediate or replace a pole based on the output 316. For instance, pole characterization code 200, in addition to providing an indication of one or more pole characteristics, such as lean angle, lean direction, etc., can initiate a remediation action (e.g., repair, replace, maintain and/or inspect, etc.) based, for instance, on the determined lean angle exceeding a specified threshold. In one example, a remediation action is initiated by automatically sending, for instance, an indication to commence the action. As an example, the indication is sent by a computer (e.g., computer 101 (FIG. 1A)), a processor of a processer set (e.g., processor set 110 (FIG. 1A)) and/or processing circuitry of a processor set (e.g., processor set 110) (FIG. 1A) to a computing or electronic component that receives the indication and automatically initiates the action. Alternatively, or additionally, the one or more indications can be sent to a utility work, group, or other entity that initiates and/or performs the remediation action. Based on initiating the remediation action, the action is performed. As examples, a pole can be replaced, or further supported, for instance, by an additional pole, by one or more guy wires, etc. One or more aspects of this remediation action can be performed manually and/or automatically (e.g., using one or more robotic devices). As noted, many possibilities exist.

As discussed, it is often necessary to monitor or inspect utility infrastructure, including utility poles. Leaning poles can be fairly common in a utility network. Poles can lean from their original position due to a variety of factors, such as weather conditions or human-related actions. A utility can rectify a leaning pole either by replacing the pole or pinning the pole to the ground or other structure using (for instance) one or more additional wires (e.g., guy wires) so that the pole has less risk of falling, thereby mitigating the risk of harm, power outage, wildfire spread, etc. A typical utility territory can have thousands, or even tens of thousands, of poles. Utility companies are required to periodically monitor their assets, including powerlines and poles, requiring some type of inspection. As noted, manually inspecting each pole of a utility infrastructure can be time consuming and expensive.

Disclosed herein are code and processes for data-analytics-based detecting and evaluating one or more characteristics of, for instance, a pole of a utility infrastructure. For example, in one or more embodiments, the data analytics-based processing disclosed provides automated detection of an angle and direction of lean of a pole from LIDAR imagery, and in particular, 3D LIDAR point cloud data, with the data having been, or being, classified into pole point clusters representative of poles at multiple different pole locations within the geographic region of interest. In one or more embodiments, the LIDAR data is collected from one or more aerial devices using sensors that detect reflections of a pulsed laser beam. In operation, the reflections are recorded as millions of individual points, collectively referred to as a point cloud. As used herein, a pole point cluster refers to a cluster of LIDAR data points within a point cloud related to or representative of a pole to be characterized. As noted, in one or more embodiments, the characteristics being determined include, for instance, a lean angle and lean direction of a pole at a pole location of multiple pole locations within the geographic area. The characteristic(s) are determined from processing the LIDAR pole point clusters, and based thereon, the computing device outputs an indication of one or more pole characteristics, and can also initiate one or more actions to, for instance, remediate a leaning pole, including automatically prioritizing actions, to first address poles in greatest need of remediation or replacement. Note that although described herein with reference to a utility pole, the pole characterization code and processes disclosed can characterize poles that support utility power lines, communication lines, cell towers, other man-made structures, etc., and even natural objects such as trees. With the pole characterization code and processes disclosed, data analytics-based processing of pole point clusters is provided, which allows for better monitoring and management of pole assets to, for instance, reduce unplanned outages or other pole-related damages, such as resulting from a storm. As a result, utility operation efficiency is enhanced, as well as customer satisfaction, and environmental damage is reduced. In one or more embodiments, the pole characterization code and processes disclosed herein facilitate prioritizing sustainability of a utility infrastructure.

In one or more embodiments, classified pole LIDAR point clouds, or pole point clusters, are used to identify each pole location within a geographic area. Note that the spacing between poles is not always the same, and the LIDAR imagery can include poles from potentially other utility networks, or companies. In one or more embodiments, a utility company's Geographical Informational System (GIS) data can be used to map the pole point clusters of interest to the utility company's infrastructure. Note that in this regard, the location of a particular GIS asset might not be exactly where the pole is physically located. In contrast, the LIDAR pole point clusters representing the pole locations are in the exact physical locations of the poles.

Based on identifying a pole point cluster for a pole location that belongs to the utility infrastructure, then (in one or more embodiments) one or more machine learning models or algorithms, are applied by the pole characterization processing to fit a 3D line representation of the pole to the pole point cluster. The 3D line is then used by the processing to, for instance, determine a lean angle, and in one or more embodiments, a lean direction, of the pole (if any).

In one or more embodiments, multiple poles of a utility infrastructure to be addressed can be ordered based on the respective lean angles, with, for instance, the largest lean angles given highest priority for remediation. In embodiments, each pole in an ordered list of pole locations with non-zero pole lean can be placed into an automated work queue, or order list, to facilitate management/remediation the pole leans. Through identifying pole lean angles, the utility system can prioritize poles at greater risk for remediation first. Additional attributes contributing to risk factors can also be weighted as part of an automated prioritization of pole repair and/or replacement process. For instance, a utility may wish to prioritize leaning poles near sensitive areas such as hospitals, schools, care areas, etc. Further, poles at the junction of multiple feeders that if damaged can cause a wider range of outage, can also be given higher priority as part of the automated processing of the pole locations.

Advantageously, in one or more embodiments, the pole characterization code and processes disclosed herein are configured to address, or handle, LIDAR pole point data sparsity, as well as to address, or handle, different pole point cluster shapes. Poles can have a variety of different shapes. For instance, a utility pole can have different attachments on the pole, such as transformers, lights, guy wires, etc. Also, one or more LIDAR beams can miss parts of a pole depending, for instance, on the location and angle of scan, resulting in incomplete pole shapes and/or sparse LIDAR data points for a pole location. To address this issue, the LIDAR pole point data is first clustered into respective pole point clusters to facilitate identifying single poles within a geographical area. For each pole identified, the pole point data can be sliced or segmented along the z-axis direction to create one or more pole point segments, from which one or more features can be determined as disclosed herein. In one or more embodiments, the pole point segment features can be used to characterize the pole types, and apply a most suitable pole characterization process of multiple pole characterization processes to fit a 3D line representing the pole, and determine therefrom one or more pole characteristics, such as pole lean, pole lean direction, pole size, etc.

In practice, the sparse nature of the LIDAR point clouds, and in particular, the classified pole point clusters, can be random. Disclosed herein are pole characterization code and processes that, in one or more embodiments, offer and/or combine multiple approaches to determine one or more pole characteristics, such as pole lean, pole direction, etc. With the different process approaches, results of running the machine learning model(s) or algorithm(s) can be obtained using different tuning parameters.

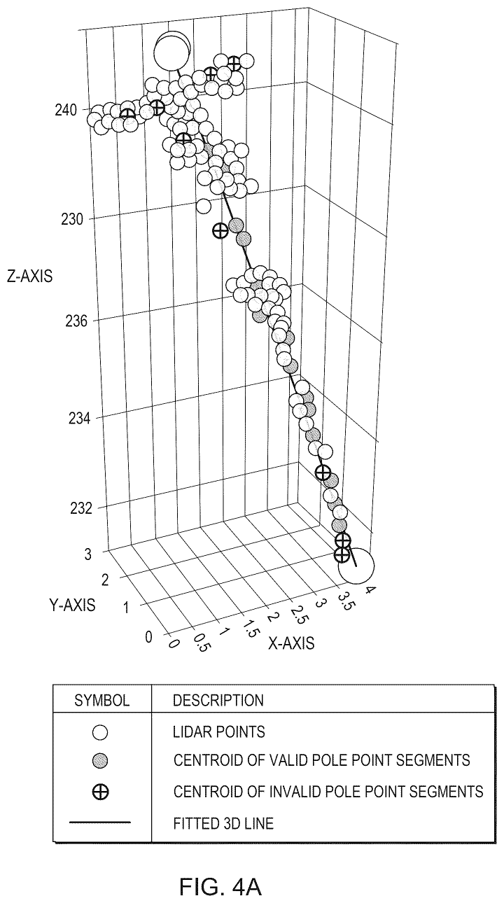

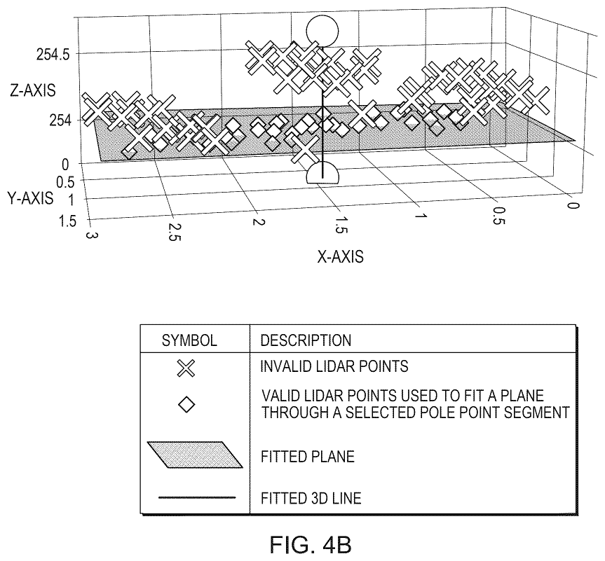

In one process approach, if there are sufficient number of pole points in a z-axis direction for a pole location, the pole points are segmented in the z-axis direction, for instance, segmented evenly, and centroids of each segment are determined. A 3D line is then fitted, using one or more machine learning models and the centroids, to approximate the location of the pole through the centroids. An example of this is depicted in FIG. 4A where centroids of multiple valid pole point segments are depicted and used to fit a 3D line representative of the pole using the pole point cluster data. Note that the example of FIG. 4A illustrates a tall LIDAR cluster process approach, where the LIDAR point data represent substantially the complete pole shape.

In another pole characterization process approach, referred to herein as a wide LIDAR cluster process, the pole point cluster may not have sufficient pole points along the z-axis direction, but does cover a larger XY area. An example of this is depicted in FIG. 4B, where a plurality of valid LIDAR pole points are used to fit a plane through a selected pole point segment. The assumption is that the larger XY area points likely represent pole arms, and an assumption is made that the pole arms are perpendicular to the pole. Thus, a 3D line is fitted perpendicular to the fitted XY plane centroid to estimate pole lean and position.

Note that, in one or more embodiments, if insufficient pole point data is available within the pole point cluster, then the pole characterization code/process can indicate that one or more pole characteristics can not be determined from the available LIDAR point cloud data.

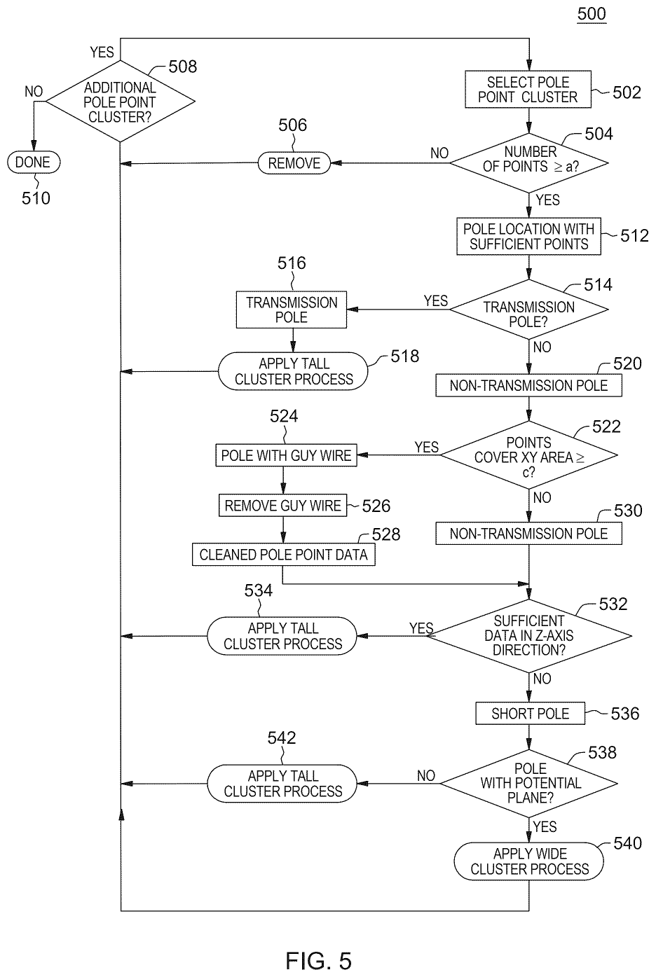

By way of further example, FIG. 5 illustrates another embodiment of a data analytics-based pole characterization workflow, in accordance with one or more aspects of present disclosure. In one or more embodiments, the data analytics-based pole characterization workflow outlined in FIG. 5 represents operations or functions implemented by program code, such as the pole characterization code 200 described herein. The workflow assumes that the type of pole within the pole point cluster distribution is yet to be determined. Pole characterization workflow 500 begins with selecting a pole point cluster 502 from a plurality of pole point clusters obtained from LIDAR point cloud data. The program code determines whether the number of pole points available in the cluster for the pole location is above a specified threshold ‘a’ 504. If “no”, then the pole point cluster is removed 506, since there is insufficient data to dynamically determine one or more pole characteristics from the data. Program code determines whether there is an additional pole point cluster to be processed 508, and if “yes”, then selects another pole point cluster 502. Once all pole point clusters have been processed by the code, then the process is complete 510.

In one or more embodiments, assuming that the number of data points in the pole point cluster is greater than or equal to the specified minimum threshold ‘a’, then processing has identified a pole location with sufficient points 512 to be considered. In one or more embodiments, program code determines whether the pole point cluster represents a transmission pole 514, and if the pole point cluster is for a transmission pole 516, then the tall cluster process 518 (of, for instance, FIGS. 4A & 6) is applied to determine one or more pole characteristics, such as described herein.

Assuming that the pole point cluster represents a non-transmission pole 520, then the program code determines whether the pole point cluster includes a pole point segment with an XY area greater than or equal to an XY area threshold ‘c’ 522. If “yes”, then a pole with a guy wire is assumed 524 and the program code processes the pole point cluster to remove the guy wire data points 526, resulting in a cleaned pole point dataset 528. Where no pole point segment has an XY area greater than the specified threshold ‘c’, then the non-transmission pole 530, or the cleaned pole point data 528, is used by the program code to determine whether there is sufficient data in the z-axis direction 532 to apply the tall cluster process 534. If “yes”, then the tall cluster process is applied 534 after which the program code determines whether there is an additional pole point cluster to be processed, and if so, the process is repeated. Assuming that there is insufficient data in the z-axis direction, then a short pole 536 has been identified by the program code, and the program code determines whether the pole has a potential large XY plane associated with it 538. For instance, in one or more embodiments, determining whether the pole has a potential large XY plane associated with it can involve comparing the XY area of the plane to a specified threshold value. If “yes”, then the wide cluster process 540 (of, for instance, FIGS. 4B & 6) is applied to the pole point cluster. If “no”, then the tall cluster process 542 is applied to the pole point cluster, in one embodiment.

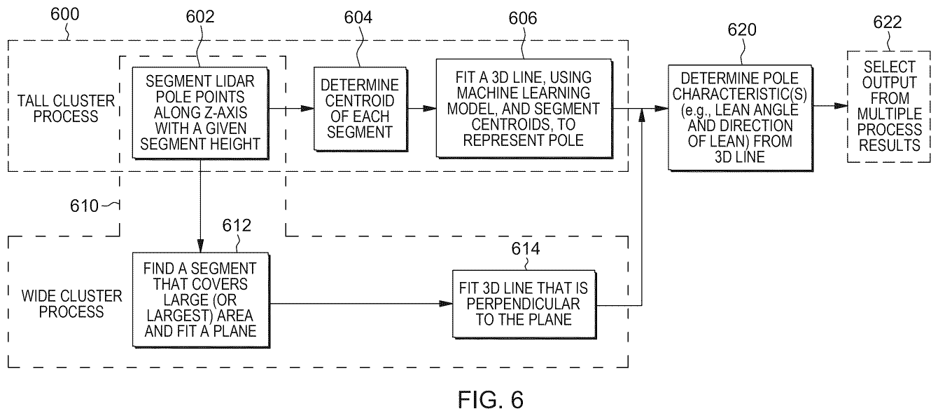

FIG. 6 illustrates a further embodiment of a data analytics-based pole characterization workflow, in accordance with one or more aspects of the present disclosure. In one or more embodiments, the data analytics-based pole characterization workflow outlined in FIG. 6 represents operations or functions implemented by program code, such as the pole characterization code 200 described herein. As disclosed herein, in one or more embodiments, pole point clusters are obtained, for instance, by classifying pole LIDAR data to identify single pole locations in a geographic region of interest. For each pole point cluster identified, the LIDAR point data can be segmented along a z-axis direction 602 with, in one or more embodiments, the segments having a given (e.g., uniform) segment height. The segment features are then used to characterize the shape of the LIDAR point cloud data, and apply the most suitable pole characterization process to fit a 3D line representation of the pole, and determine one or more pole characteristics. As noted, multiple pole characterization processes can be considered, including, for instance, a tall cluster process 600, and a wide cluster process 610, with different examples of such pole point clusters being depicted in FIGS. 4A & 4B, respectively.

Assuming that the pole point cluster has sufficient pole points in the z-axis direction, then the tall cluster process 600 is selected, as discussed above in connection with FIG. 5, and a centroid of each pole point segment is determined 604. One or more machine learning models or algorithms are used to fit a 3D line representation of the pole to the pole point cluster using the segment centroids 606. Note that, in this regard, the LIDAR point data is assumed to be 3D point data, and that determining the centroids of each pole point segment and using the centroids to fit the 3D model to the data, enhances accuracy of the resultant line, with the resultant line being used to determine one or more pole characteristics 620, as desired for a particular implementation. For instance, the one or more pole characteristics can include pole lean angle and/or pole direction of lean, etc.

Assuming that the shape of the pole point cluster at issue has insufficient points along the z-axis (e.g., has a number of data points less than a specified threshold), then the wide cluster process 610 can be used, as described above in connection with the workflow of FIG. 5. In this process, program code finds a pole point segment that covers a large, or largest, XY area at the pole location and fits an XY plane to that area 612. Once the XY plane is determined by, for instance, one or more machine learning models, the process fits a 3D line that is perpendicular to the centroid of the plane 614 to obtain the 3D line representation of the pole at that pole location. Based on determining the 3D line representation, the program code determines one or more specified pole characteristics from the 3D line, such as lean angle, lean direction, etc. 620.

In one or more embodiments, where the pole point cluster contains point cloud data useful for either the tall cluster process or the wide cluster process, then both processes can be run on the pole point cluster to determine two different sets of pole characteristics from the two processes. In such an embodiment, the program code can be configured to select the best output of the pole characterization processes as the result 622, for output and/or use to initiate an action, such as an action to remediate one or more poles in the utility infrastructure.

One or more aspects of the present invention are tied to computer technology and facilitate processing within a computer, improving performance thereof in characterizing one or more features of a pole. In one or more aspects, the technical field of remote sensing (including LIDAR imaging) and processing thereof is improved by improving the detection of poles within a geographical region of interest and the characterization of one or more features of the pole. One or more aspects improve current pole detection and characterization using, for instance, LIDAR cloud points, and in particular, cloud points based on 3D LIDAR point data.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other models and/or weather data may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features.

Furthermore, a device or structure that is configured in a certain way is configured in at least that way, but may also be configured in ways that are not listed. The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
receiving, by a computing device over one or more networks, Light Detection and Ranging (LIDAR) pole point clusters, the LIDAR pole point clusters being derived from 3D LIDAR point cloud data obtained from LIDAR sensors on one or more devices, the pole point clusters corresponding to multiple pole locations within a geographic region of interest;
processing, by the computing device using one or more machine learning models, a pole point cluster for a pole location of the multiple pole locations, the processing comprising:
fitting a 3D line representation of a pole at the pole location to the pole point cluster, the fitting including segmenting a plurality of pole points of the pole point cluster at the pole location along a z-axis direction to obtain one or more pole point segments in the z-axis direction, and using at least one pole point segment of the one or more pole segments in fitting the 3D line representation of the pole at the pole location to the pole point cluster;
determining from the 3D line representation a lean angle of the pole at the pole location; and
outputting, by the computing device, an indication of the lean angle of the pole at the pole location.

2. The computer-implemented method of claim 1, wherein the processing, by the computing device using the one or more machine learning models, further comprises determining a centroid of each pole point segment of the one or more pole point segments, wherein the processing, using the one or more machine learning models, fits the 3D line representation of the pole using the one or more centroids of the one or more pole point segments.

3. The computer-implemented method of claim 2, wherein the processing, by the computing device using the one or more machine learning models, further comprises:
determining whether an amount of pole point data of the pole point cluster in the z-axis direction exceeds a specified threshold, where determining the centroid of each pole point segment of the one or more pole point segments, and the fitting of the 3D line representation of the pole using the one or more centroids of the one or more pole point segments, are based on determining that the amount of pole point data in the z-axis direction exceeds the specified threshold.

4. The computer-implemented method of claim 2, wherein the processing, by the computing device using the one or more machine learning models, further comprises:
selecting a pole point segment of the one or more pole point segments with a largest XY cloud point coverage area;
fitting an other 3D line representation to the selected pole point segment with the largest XY coverage area that is perpendicular to the XY coverage area of the selected pole point segment;
determining, using the other 3D line representation of the pole at the pole location, an other lean angle of the pole at the pole location; and
selecting for output one of: the lean angle of the pole at the pole location determined from the 3D line fitted using the one or more centroids of the one or more pole point segments; and the another lean angle of the pole at the pole location determined from the selected pole point segment with the largest XY coverage area of the one or more pole point segments.

5. The computer-implemented method of claim 1, wherein the processing, by the computing device using the one or more machine learning models, further comprises:
selecting a pole point segment of the one or more pole point segments with the largest XY coverage area; and
wherein fitting the 3D line representing the pole at the pole point location to the pole point cluster comprises fitting the 3D line representation of the pole at the pole point location perpendicular to the XY coverage area of the selected pole point segment.

6. The computer-implemented method of claim 5, wherein the processing, by the computing device using one or more machine learning models, further comprises:
determining whether an amount of pole point data of the pole point cluster in the z-axis direction exceeds a specified threshold, where selecting the pole point segment of the plurality of the pole point segments with the largest XY coverage area and fitting of the 3D line representation perpendicular to the XY coverage area of the selected pole point segment, are based on determining that the amount of pole point data in the z-axis direction is less than the specified threshold.

7. The computer-implemented method of claim 1, further comprising processing the pole point cluster to remove non-pole point data, where the segmenting is based on removal of the non-pole point data.

8. The computer-implemented method of claim 1, wherein the processing, by the computing device using the one or more machine learning models, the pole point cluster of the pole location further comprises determining from the 3D line a lean direction of the pole at the pole location.

9. The computer-implemented method of claim 1, further comprising initializing an action to provide support to the pole at the pole location based on the outputted indication of lean angle of the pole at the pole location.

10. The computer-implemented method of claim 1, further comprising detecting, using the LIDAR sensors on the one or more devices, the multiple pole locations within the geographic region by generating one or more LIDAR point clouds, and identifying therefrom the LIDAR pole point clusters.

11. The computer-implemented method of claim 10, further comprising comparing the multiple LIDAR pole point clusters to geographical information system (GIS) data to map each pole location of the multiple pole locations to a utility's infrastructure within the geographic region of interest.

12. The computer-implemented method of claim 1, further comprising repeating the processing for each of the multiple pole locations to derive corresponding lean angles of multiple poles at the multiple pole locations, and wherein the outputting comprises ordering the multiple poles with respect to the corresponding lean angles determined for the poles at the multiple pole locations.

13. A computer program product comprising:
a set of one or more computer-readable storage media; and
program instructions, collectively stored in the set of one or more computer-readable storage media, for causing at least one computing device to perform computer operations including:
receiving Light Detection and Ranging (LIDAR) pole point clusters, the LIDAR pole point clusters being derived from 3D LIDAR point cloud data obtained from LIDAR sensors on one or more devices, the pole point clusters corresponding to multiple pole locations within a geographic region of interest;
processing, using one or more machine learning models, a pole point cluster for a pole location of the multiple pole locations, the processing comprising:
fitting a 3D line representation of a pole at the pole location to the pole point cluster, the fitting including segmenting a plurality of pole points of the pole point cluster at the pole location along a z-axis direction to obtain one or more pole point segments in the z-axis direction, and using at least one pole point segment of the one or more pole segments in fitting the 3D line representation of the pole at the pole location to the pole point cluster;
determining from the 3D line representation a lean angle of the pole at the pole location; and
outputting an indication of the lean angle of the pole at the pole location.

14. The computer program product of claim 13, wherein the processing, by the computing device using the one or more machine learning models, further comprises determining a centroid of each pole point segment of the one or more pole point segments, wherein the processing, using the one or more machine learning models, fits the 3D line representation of the pole using the one or more centroids of the one or more pole point segments.

15. The computer program product of claim 14, wherein the processing, by the computing device using the one or more machine learning models, further comprises:
selecting a pole point segment of the one or more pole point segments with a largest XY cloud point coverage area;
fitting an other 3D line representation to the selected pole point segment with the largest XY coverage area that is perpendicular to the XY coverage area of the selected pole point segment;
determining, using the other 3D line representation of the pole at the pole location, an other lean angle of the pole at the pole location; and
selecting for output one of: the lean angle of the pole at the pole location determined from the 3D line fitted using the one or more centroids of the one or more pole point segments; and the another lean angle of the pole at the pole location determined from the selected pole point segment with the largest XY coverage area of the one or more pole point segments.

16. The computer program product of claim 13, wherein the processing, by the computing device using the one or more machine learning models, further comprises:
selecting a pole point segment of the one or more pole point segments with the largest XY coverage area; and
wherein fitting the 3D line representing the pole at the pole point location to the pole point cluster comprises fitting the 3D line representation of the pole at the pole point location perpendicular to the XY coverage area of the selected pole point segment.

17. The computer program product of claim 16, wherein the processing, by the computing device using one or more machine learning models, further comprises:
determining whether an amount of pole point data of the pole point cluster in the z-axis direction exceeds a specified threshold, where selecting the pole point segment of the plurality of the pole point segments with the largest XY coverage area and fitting of the 3D line representation perpendicular to the XY coverage area of the selected pole point segment, are based on determining that the amount of pole point data in the z-axis direction is less than the specified threshold.

18. A computer system comprising:
at least one computing device;
a set of one or more computer-readable storage media; and
program instructions, collectively stored in the set of one or more computer-readable storage media, for causing the at least one computing device to perform computer operations including:
receiving Light Detection and Ranging (LIDAR) pole point clusters, the LIDAR pole point clusters being derived from 3D LIDAR point cloud data obtained from LIDAR sensors on one or more devices, the pole point clusters corresponding to multiple pole locations within a geographic region of interest;
processing using one or more machine learning models, a pole point cluster for a pole location of the multiple pole locations, the processing comprising:
fitting a 3D line representation of a pole at the pole location to the pole point cluster, the fitting including segmenting a plurality of pole points of the pole point cluster at the pole location along a z-axis direction to obtain one or more pole point segments in the z-axis direction, and using at least one pole point segment of the one or more pole segments in fitting the 3D line representation of the pole at the pole location to the pole point cluster;
determining from the 3D line representation a lean angle of the pole at the pole location; and
outputting an indication of the lean angle of the pole at the pole location.

19. The computer system of claim 18, wherein the processing, by the computing device using the one or more machine learning models, further comprises:
determining that an amount of pole point data in the pole point cluster in the z-axis direction exceeds a specified threshold, and based on the amount of pole point data exceeding the specified threshold, determining a centroid of each pole point segment of the one or more pole point segments, wherein the fitting of the 3D line representation of the pole is based on the one or more centroids of the one or more pole segments.

20. The computer system of claim 18, wherein the processing, by the computing device using the one or more machine learning models, comprises:
determining that an amount of pole point data in the pole point cluster in the z-axis direction is less than a specified threshold, and based on determining that the amount of pole point data is less than the specified threshold, selecting a pole point segment of the one or more pole point segments with a largest XY coverage area, wherein the fitting of the 3D line representation of the pole at the pole point location to the pole point cluster comprises fitting the 3D line representation of the pole perpendicular to the XY coverage area of the selected pole point segment.
